(19) United States
(12) Patent Application Publication
(10) Pub. No.: US 2026/0247022 A1
(43) Pub. Date: Aug. 20, 2026

(54) PHOTOGRAPHING METHOD AND SYSTEM FOR AUTOMATICALLY TRACKING TARGET OBJECT, AND COMPUTER DEVICE

(71) Applicant: AAC Microtech (Changzhou) Co., Ltd., Changzhou City (CN)

(72) Inventor: Xiujiang Si, Changzhou (CN)

(21) Appl. No.: 19/307,046

(22) Filed: Aug. 22, 2025

Related U.S. Application Data
(63) Continuation of application No. PCT/CN2025/077634, filed on Feb. 17, 2025.

(51) Int. Cl. H04N 23/61; G06T 7/73; G06V 10/74; G06V 10/75; H04N 23/53

(52) U.S. Cl. CPC H04N 23/61; G06T 7/74; G06V 10/751; G06V 10/761; H04N 23/531

(57) ABSTRACT

A photographing method and system for automatically tracking a target object, and a computer device are provided. The photographing method is applied to an electronic device and includes: recording the target object into the electronic device, and performing feature extraction on the target object; in response to a received photographing instruction, controlling a camera to photograph the target object; determining whether the target object is located in a center of a current photographed image; if it is determined that the target object is not located in the center of the current photographed image, controlling a first screen to rotate relative to a second screen until the target object is adjusted to the center of the photographed image. The target object can be automatically tracked to ensure that the target object is located in the center of the photographed image, thereby providing a user with a stable and coherent photographing experience.

### CROSS-REFERENCE TO RELATED APPLICATIONS

This application is a continuation of International Application No. PCT/CN2025/077634, filed on Feb. 17, 2025, the entire content of which is incorporated herein by reference.

### TECHNICAL FIELD

The present invention belongs to the technical field of intelligent photographing, and in particular to, a photographing method and system for automatically tracking a target object, and a computer device.

### BACKGROUND

With the popularity of smart phones, the photo-taking performance of the smart phones has received increasing attention from mobile phone manufacturers. Almost all the mobile phone manufacturers have launched mobile phones with front-facing and rear-facing cameras. When a traditional mobile phone is used to take a photo, a photographer needs to locate a target object. When the target object is in a high-speed motion state, it is difficult for the photographer to accurately control the mobile phone to make the target object stably in a center of a photographed image.

When the photographer is to take a video of the photographer, the photographer cannot leave a photographing range of a camera of the mobile phone, and cannot do some significant movements or change different scenes, so the photographer can only take the video at a fixed angle, which limits an activity space of the photographer to a particular extent.

### SUMMARY

The present invention provides a photographing method and system for automatically tracking a target object, and a computer device, which can automatically track the target object, ensure that the target object is always in a center of a photographed image, and improve the photographing quality.

In order to solve the technical problem, in the first aspect, the present invention provides a photographing method for automatically tracking a target object, applied to an electronic device. The electronic device includes a first screen provided with a camera and a second screen rotatably connected to the first screen; the first screen and the second screen are located on the same side of the electronic device; and the method includes: recording the target object into the electronic device, and performing feature extraction on the target object; in response to a received photographing instruction, controlling the camera to photograph the target object; determining whether the target object is located in a center of a current photographed image, and if it is determined that the target object is not located in the center of the current photographed image, controlling the first screen to rotate relative to the second screen until the target object is adjusted to the center of the photographed image; and if it is determined that the target object is located in the center of the current photographed image, continuing to control the camera to photograph the target object.

As an improvement of the present invention, the recording the target object into the electronic device, and performing feature extraction on the target object includes: photographing a multi-angle picture of the target object through the camera, or selecting, from a photo album of the electronic device, a picture containing the target object as an information source, to extract a feature of the target object based on the picture of the target object; or, inputting a name of the target object to the electronic device through speech or text, to cause the electronic device to automatically generate a feature of the target object; or, manually tapping the target object on the current photographed image of the electronic device to implement the feature extraction on the target object. The feature of the target object at least includes a first feature and a second feature.

As an improvement of the present invention, before the determining whether the target object is located in a center of a photographed image, the method further includes: extracting a first feature and a second feature in the current photographed image, and respectively comparing the first feature and the second feature of the current photographed image with the first feature and the second feature of the target object, to determine whether the target object is located in the current photographed image.

As an improvement of the present invention, the determining whether the target object is located in the current photographed image includes: comparing the current photographed image of the camera with the extracted first feature and the extracted second feature to obtain a first feature similarity and a second feature similarity of the current photographed image; assigning weights to the first feature and the second feature, and determining, when a comprehensive similarity of the current photographed image is greater than a preset similarity threshold, that the target object is located in the current photographed image; and on the contrary, if it is determined that the target object is not located in the current photographed image, controlling the first screen to rotate relative to the second screen until the target object is adjusted to the photographed image.

As an improvement of the present invention, the determining whether the target object is located in a center of a current photographed image includes: when the target object is located in the photographed image, determine contour position coordinates of the target object in the current photographed image based on the first feature of the target object; determining center position coordinates of the target object based on a mean value of a plurality of contour position coordinates, and comparing the center position coordinates with coordinates of the center of the current photographed image; when a difference between the center position coordinates and the coordinates of the center of the current photographed image is less than a preset threshold, determining that the target object is located in the center of the current photographed image; and on the contrary, controlling the first screen to rotate relative to the second screen until the target object is adjusted to the center of the photographed image.

As an improvement of the present invention, the first feature is a shape feature of the target object, and the second feature is a color feature of the target object.

As an improvement of the present invention, an actuator is arranged between the first screen and the second screen, and the actuator is configured to control the rotation of the first screen relative to the second screen and hover the first screen to a desired photographing angle.

In the second aspect, the present invention also provides a photographing system for automatically tracking a target object, configured to perform the steps of the photographing method for automatically tracking the target object described above. the photographing system includes: an extraction unit, configured to: record the target object into an electronic device, and perform feature extraction on the target object; a responding unit, configured to: in response to a received photographing instruction, control a camera to photograph the target object; a determining unit, configured to determine whether the target object is located in a center of a current photographed image; and a control unit, configured to: when the target object is not located in the center of the current photographed image, control a first screen to rotate relative to a second screen until the target object is adjusted to the center of the photographed image; and when the target object is located in the center of the current photographed image, continue to control the camera to photograph the target object.

In the third aspect, the present invention provides a computer device, including a processor and a memory coupled with the processor, wherein the memory has a computer program stored therein, and the computer program, when executed by the processor, causes the processor to perform the steps of the photographing method for automatically tracking the target object described above.

Compared with the prior art, the photographing method for automatically tracking the target object provided in the present invention, the target object is input to the electronic device. By performing the feature extraction on the target object through the electronic device, whether the target object is located in the center of the current photographed image is determined in real time in the photographing process. If it is determined that the target object is not located in the center of the current photographed image, the first screen is controlled to rotate relative to the second screen until the target object is adjusted to the center of the photographed image. The present invention can automatically track the target object to ensure that the target object is located in the center of the photographed image, thereby providing a user with a stable and coherent photographing experience.

### BRIEF DESCRIPTION OF THE DRAWINGS

In order to explain the technical solutions of the embodiments of the present invention more clearly, the following will briefly introduce the accompanying drawings used in the embodiments. Apparently, the drawings in the following description are only some embodiments of the present invention. Those of ordinary skill in the art can obtain other drawings based on these drawings without creative work.

FIG. 1 is a schematic structural diagram of an electronic device according to an embodiment of the present invention.

FIG. 2 is a flowchart of a photographing method for automatically tracking a target object according to an embodiment of the present invention.

FIG. 3 is a diagram of a first embodiment of a photographing method for automatically tracking a target object according to an embodiment of the present invention.

FIG. 4 is a diagram of a second embodiment of a photographing method for automatically tracking a target object according to an embodiment of the present invention.

FIG. 5 is a diagram of a third embodiment of a photographing method for automatically tracking a target object according to an embodiment of the present invention.

FIG. 6 is a schematic structural diagram of a photographing system for automatically tracking a target object according to an embodiment of the present invention.

FIG. 7 is a schematic structural diagram of a computer device according to an embodiment of the present invention.

FIG. 8 is a schematic structural diagram of a storage medium according to an embodiment of the present invention.

### DETAILED DESCRIPTION OF THE EMBODIMENTS

In order to make the aims, technical solution and advantages of the present invention will be clearly, the present invention is further described below in combination with accompanying drawings and implementations. It should be understood that the specific embodiments described herein are intended only to explain the present invention and are not intended to define the present invention.

In the description of the embodiments of the present invention, “plurality” means at least two, such as two and three unless it is specifically defined otherwise. All directional indications (such as up, down, left, right, front, back . . . ) involved in the embodiments of the present invention are only used to explain the relative positional relationship, motion states, and the like between various components in specific postures (as shown in the accompanying drawings). If the specific postures change, the directional indications also change correspondingly. In addition, the term “include”, “has”, and any variant thereof are intended to cover a non-exclusive inclusion.

To make the description of the disclosed content more detailed and complete, the following provides explanatory descriptions for implementations of embodiments and specific embodiments of the present invention. However, this is not the only form of implementing or applying the specific embodiments of the present invention. The implementations cover the features of a plurality of specific embodiments, as well as method steps configured to construct and operate these specific embodiments, and a sequence of the metal steps. However, other specific embodiments can also be used to achieve the same or equal functions and sequence of steps.

In the embodiments of the present invention, the terms “exemplary”, “in some embodiments”, “in another embodiment”, and the like are used to represent giving an example, an illustration, or a description. Any embodiment or design scheme described by using “exemplary” in the present invention should not be explained as being more preferred or having more advantages than another embodiment or design scheme. To be specific, the term “exemplarily” as used herein is intended to present the concept in a specific implementation.

The embodiments of the present invention can obtain and process relevant data based on an artificial intelligence technology. Artificial intelligence (AI) is a theory, method, technology, and application system that uses a digital computer or a machine controlled by the digital computer to simulate, extend, and expand human intelligence, perceive an environment, acquire knowledge, and use knowledge to obtain an optimal result.

Basic AI technologies generally include technologies such as a sensor, a dedicated AI chip, cloud computing, distributed storage, a big data processing technology, an operating/interaction system, and electromechanical integration. An artificial intelligence software technology mainly includes some major directions such as a computer vision technology, a robot technology, a biological recognition technology, a speech processing technology, a natural language processing technology, and machine learning/deep learning.

When a traditional mobile phone is used to take a photo, a photographer needs to locate a target object. When the target object is in a high-speed motion state, it is difficult for the photographer to accurately control the mobile phone to make the target object stably in a center of a photographed image.

When the photographer is to take a video of the photographer, the photographer cannot leave a photographing range of a camera of the mobile phone, and cannot do some significant movements or change different scenes, so the photographer can only take the video at a fixed angle, which limits an activity space of the photographer to a particular extent.

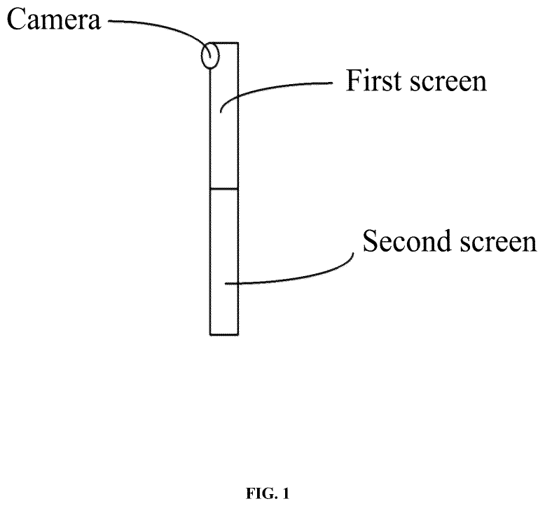

In view of this, referring to FIG. 1 to FIG. 8, the embodiments of the present invention provide a photographing method and system for automatically tracking a target object, a device, and a storage medium, which can automatically track the target object, ensure that the target object is always in a center of a photographed image, and improve the photographing quality.

It should be noted that the method for automatically tracking a target object of the present invention is applicable to any electronic device with a photographing function and screens on two opposite sides, such as a foldable phone, a tablet computer, and a smart wearable device. The present invention does not limit this. For ease of description, the present invention will be described by taking a foldable phone that is folded vertically as an example. Certainly, a foldable phone that is folded laterally is also feasible. It can be understood that the technical solutions of the present invention are also applicable to other applications with photographing functions on an electronic device, not limited to a camera application.

Referring to FIG. 1, it is a schematic structural diagram of an electronic device according to an embodiment of the present invention. The electronic device includes a first screen provided with a camera and a second screen rotatably connected to the first screen. The first screen and the second screen are arranged on the same side of the electronic device. The first screen and the camera can be arranged on different sides of the electronic device or on the same side of the electronic device. The present invention does not further limit this.

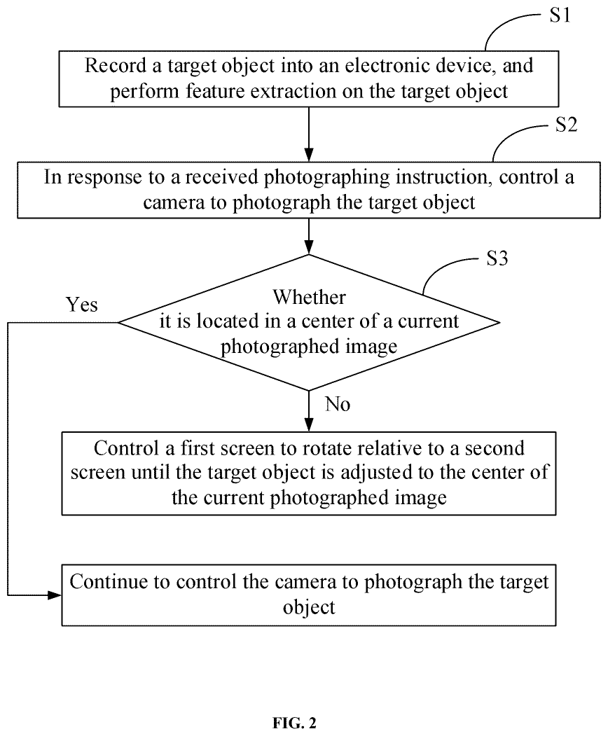

On the basis of the above structure of the electronic device, referring to FIG. 2, it is a flowchart of a photographing method for automatically tracking a target object according to an embodiment of the present invention. The photographing method includes the following steps:

Step S1: Record the target object into the electronic device, and perform feature extraction on the target object.

In an optional implementation, the recording the target object into the electronic device, and performing feature extraction on the target object includes:

photographing a multi-angle picture of the target object through the camera, or selecting, from a photo album of the electronic device, a picture containing the target object as an information source, to extract a feature of the target object based on the picture of the target object;

or, inputting a name of the target object to the electronic device through speech or text, to cause the electronic device to automatically generate a feature of the target object;

or, manually tapping the target object on the current photographed image of the electronic device to implement the feature extraction on the target object,

where the feature of the target object at least includes a first feature and a second feature.

In this embodiment of the present invention, since the electronic device usually has a photographing function and a camera application function, the target object can be photographed through the camera provided on the electronic device.

If conditions permit, the target object can be photographed at the same fixed angle and can be photographed in different directions and perspectives around the target object, to display different details and features of the target object and provide richer and more comprehensive image information for subsequent feature extraction.

Alternatively, the camera application function of the electronic device is used, and an example in which the target object is a selfie taker is used. A camera of the electronic device usually stores various selfie photos previously taken or saved by a user. The selfie taker can directly select relevant selfie photos as an information source for the subsequent feature extraction. Alternatively, an example in which the target object is a pet is used. The photographer directly selects relevant photos of the pet. This mode of directly applying existing image resources without a need for taking photos in advance is also feasible and can be applicable to different application scenarios and photographing needs.

Optionally, a name of the target object can be input to the electronic device through speech or text. The photographer directly inputs the name of the target object, such as the pet, to the electronic device through speech or text, so that the electronic device automatically generates the feature of the target object based on the received name of the target object.

Further, the target object can be manually tapped on the current photographed image of the electronic device. For example, when the photographer needs to photograph a moving pet, the pet can be manually selected on the current photographed image of the electronic device, so that the electronic device performs feature extraction on the currently selected target object.

The above modes for extracting the feature of the target object are all feasible. The present invention does not impose many restrictions. Those skilled in the art should be aware of this.

Further, after a picture of the target object is obtained, the first feature and the second feature of the target object need to be extracted.

Exemplarily, the first feature can be a shape feature of the target object, and the second feature can be a color feature of the target object. Certainly, the first feature and the second feature can also be texture features, contour features, and other relevant features of the target object. Those skilled in the art should be aware of this.

An example in which the first feature is the shape feature of the target object is used. An edge shape of the target object can be obtained through a traditional edge detection operator, or an edge pixel of the target object can be determined through a convolutional neural network (CNN) detection model, thus obtaining an edge shape of the target object. A contour of the target object can also be continuously updated through a Snakes model until convergence, thereby obtaining a final edge shape of the target object. The above modes for obtaining the shape feature of the target object are all feasible. The present invention will not elaborate a specific mode and steps of how to extract the shape feature of the target object.

Further, an example in which the second feature is the color feature of the target object is used. The color feature of the target object can be obtained through a traditional mode of color space transformation and histogram statistics, such as color combinations of hue, saturation, and brightness that the target object mainly contains. Alternatively, the color feature of the target object can be extracted through a color moment, color quantization, or some existing training models. The above modes for obtaining the color feature of the target object are also feasible. The present invention will not elaborate a specific mode and steps of how to extract the color feature of the target object.

Step S2: In response to a received photographing instruction, control the camera to photograph the target object.

In this embodiment of the present invention, when the electronic device receives the photographing instruction, the electronic device may initiate a corresponding operation such as controlling the camera to photograph the target object. The target object herein is a specific object to be photographed, which may have been predetermined by the electronic device or specifically determined by a user in a particular way.

It can be understood that the user can also control the camera to capture the target object through a speech command, a Bluetooth command, or another way. The present invention does not impose many restrictions on a specific form of the above photographing instruction.

Step S3: Determine whether the target object is located in a center of a current photographed image; if it is determined that the target object is not located in the center of the current photographed image, control the first screen to rotate relative to the second screen until the target object is adjusted to the center of the photographed image; and

if it is determined that the target object is located in the center of the current photographed image, continue to control the camera to photograph the target object.

In an optional implementation, before the determining whether the target object is located in a center of the photographed image, the method further includes:

extracting a first feature and a second feature in the current photographed image, and respectively comparing the first feature and the second feature of the current photographed image with the first feature and the second feature of the target object, to determine whether the target object is located in the current photographed image.

In this embodiment of the present invention, the electronic device may obtain the first feature and the second feature in real time from the current photographed image in the process of photographing the target object, such as the shape feature and the color feature in the photographed image.

It can be understood that the above process of obtaining the first feature and the second feature is carried out simultaneously in the process of photographing the target object, and feature extraction and analysis may be performed on the current photographed image in real time, without affecting the normal photographing on the target object.

After the first feature and the second feature in the current photographed image are obtained in real time, the first feature of the current photographed image may be compared with the first feature of the target object, and the second feature of the current photographed image may be compared with the second feature of the target object. Based on the comparison of the above features, whether the target object is located in the current photographed image is determined.

It should be noted that when a user needs to carry out photographing in a particular photographing scenario, there may be a situation that the photographing instruction is issued to control the camera for photographing, but the user needs to move to the photographing scenario. Therefore, in the moving process, the target object is not located in the photographed image. Therefore, the present invention adds the step of determining whether the target object is located in the photographed image. After it is determined that the target object is located in the photographed image, whether the target object is located in the center of the photographed image is then further determined.

In an optional implementation, the determining whether the target object is located in the current photographed image includes:

comparing the current photographed image of the camera with the extracted first feature and the extracted second feature to obtain a first feature similarity and a second feature similarity of the current photographed image;

assigning weights to the first feature and the second feature, and determining, when a comprehensive similarity of the current photographed image is greater than a preset similarity threshold, that the target object is located in the current photographed image; and

on the contrary, if it is determined that the target object is not located in the current photographed image, controlling the first screen to rotate relative to the second screen until the target object is adjusted to the photographed image.

In this embodiment of the present invention, after the first feature and the second feature in the current photographed image are obtained in real time, the first feature of the current photographed image is compared with the first feature of the target object, and the second feature of the current photographed image is compared with the second feature of the target object, to further obtain the first feature similarity and the second feature similarity between the current photographed image and the target object.

Exemplarily, when the first features are shape features, the first feature similarity can be determined by calculating a difference between their fast Fourier transform coefficients based on a Fourier descriptor, or the desired first feature similarity can be calculated based on a difference of different order moments by using a moment descriptor. The above modes for calculating the first feature similarity are all feasible.

When the second features are color features, a color histogram of the current photographed image can be compared with a color histogram of the target object, and a distance between the color histogram of the current photographed image and the color histogram of the target object can be calculated as a similarity measure. For example, the desired second feature similarity is calculated by using a Bhattacharyya distance, a Euclidean distance, or a cosine similarity.

It can be understood that calculating a feature similarity is a very common and basic operation in technology research and application practice of image recognition and related fields. The above modes for calculating the first feature similarity and the second feature similarity are widely recorded and applied. The present invention will not elaborate this in detail here.

Further, after the first feature similarity and the second feature similarity are calculated, the corresponding weights can be assigned to the first feature and the second feature based on an application requirement or importance of the first feature and the second feature, to obtain a comprehensive similarity S of the current photographed image.

Specifically, the desired comprehensive similarity can be calculated based on formula S=W1*S1+W2* S2, where W1+W2=1; S1 represents the first feature similarity; W1 represents the weight assigned to the first feature; S2 represents the second feature similarity; and W2 represents the weight assigned to the second feature. Certainly, specific numerical allocation of W1 and W2 can also be adjusted and optimized based on actual needs. Those skilled in the art should be aware of it.

Further, the comprehensive similarity of the current photographed image is compared with a preset similarity threshold. When the comprehensive similarity of the current photographed image is greater than the preset similarity threshold, it is determined that the target object has already been located in the current photographed image.

On the contrary, when the comprehensive similarity of the current photographed image is less than or equal to the preset similarity threshold, it is determined that the target object is not located in the current photographed image. Therefore, the first screen needs to be controlled to rotate relative to the second screen, so that the target object is adjusted to the photographed image.

It should be noted that in the process of adjusting the target object to the photographed image, the accuracy of adjusting the first screen relative to the second screen may be relatively greater than the accuracy of the process of adjusting the target object to the center of the photographed image. That is, an angle of the first screen relative to the second screen is roughly adjusted first. After the target object enters the photographed image, the angle of the first screen relative to the second screen is finely adjusted to ensure that the target object is adjusted to the center of the photographed image.

In this embodiment of the present invention, an actuator capable of controlling the rotation of the first screen relative to the second screen is arranged between the first screen and the second screen. The actuator can be implemented by using a small motor in conjunction with a transmission mechanism and a hinge. The actuator can be arranged between the first screen and the second screen, or integrated inside the electronic device. Certainly, another structure that can control the rotation of the first screen relative to the second screen to adjust an opening angle between the first screen and the second screen is also feasible. The present invention does not impose many restrictions on a specific arrangement form of the actuator.

Step S3: Determine whether the target object is located in a center of a current photographed image; if it is determined that the target object is not located in the center of the current photographed image, control the first screen to rotate relative to the second screen until the target object is adjusted to the center of the photographed image; and

if it is determined that the target object is located in the center of the current photographed image, continue to control the camera to photograph the target object.

In an optional implementation, the determining whether the target object is located in a center of a current photographed image includes:

when the target object is located in the photographed image, determine contour position coordinates of the target object in the current photographed image based on the first feature of the target object;

determining center position coordinates of the target object based on a mean value of a plurality of contour position coordinates, and comparing the center position coordinates with coordinates of the center of the current photographed image;

when a difference between the center position coordinates and the coordinates of the center of the current photographed image is less than a preset threshold, determining that the target object is located in the center of the current photographed image; and

on the contrary, controlling the first screen to rotate relative to the second screen until the target object is adjusted to the center of the photographed image.

In this embodiment of the present invention, after it is determined that the target object is located in the photographed image, whether the target object is located in the center of the current photographed image needs to be further determined.

Specifically, when it is determined that the target object is located in the photographed image, the contour position coordinates of the target object in the photographed image are determined based on the first feature of the target object, i.e. the shape feature extracted in step S2, namely based on the shape feature of the target object.

It can be understood that after the shape feature of the target object is extracted, for example, after the shape feature of the target object is extracted based on the Fourier descriptor, a common edge detection algorithm such as a Canny edge detection algorithm can be used to determine an edge of the target object. By marking a contour edge pixel of the target object, the contour position coordinates are obtained through a Moore-Neighbor tracking algorithm. Certainly, the above is an exemplary implementation, and another setting mode that can determine the contour position coordinates of the target object in the photographed image is also feasible. The present invention does not impose many restrictions on this.

Further, after the plurality of contour position coordinates of the target object in the photographed image are obtained, the center position coordinates of the target object can be determined based on the mean value of the position coordinates. Since the photographed image is in a rectangular shape, the photographed image can be regarded as a two-dimensional plane. The lower left corner of the image can be determined as an origin to further obtain the coordinates of the center of the photographed image.

The center position coordinates of the target object are compared with the coordinates of the center of the current photographed image. A difference d between two coordinate points is calculated. When the difference between the center position coordinates of the target object and the coordinates of the center of the current photographed image is less than the preset threshold, it is determined that the target object is located in the center of the current photographed image, and the target object is continued to be photographed at this angle.

If the difference between the center position coordinates of the target object and the coordinates of the center of the current photographed image is greater than or equal to the preset threshold, the first screen needs to be adjusted, and the first screen is controlled to rotate relative to the second screen until the target object is adjusted to the center of the photographed image.

It can be understood that in practical applications, the mode for simply calculating the difference based on the coordinates to determine whether the target object is located in the center of the photographed image may not be accurate enough. The target object may have different postures such as movement, spinning around, and jumping. For example, when the target object approaches the camera, a proportion of the target object in the current photographed image may be large. In this case, an allowable preset threshold is small. When the target object moves away from the camera, a proportion of the target object in the current photographed image may be small. Therefore, the preset threshold can be appropriately increased.

Similarly, the preset threshold can be adjusted based on a speed of the target object. For example, when the target object is moving at a high speed, in order to track the position of the target object in a timely manner, the preset threshold can be appropriately increased in the tracking process. After the motion of the target object is stable, the preset threshold is appropriately decreased to improve the accuracy of comparison.

That is, the preset threshold provided above is not a fixed value, but can be adjusted according to an actual application scenario and a photographing situation, to improve the accuracy of determining. Those skilled in the art should be aware of this.

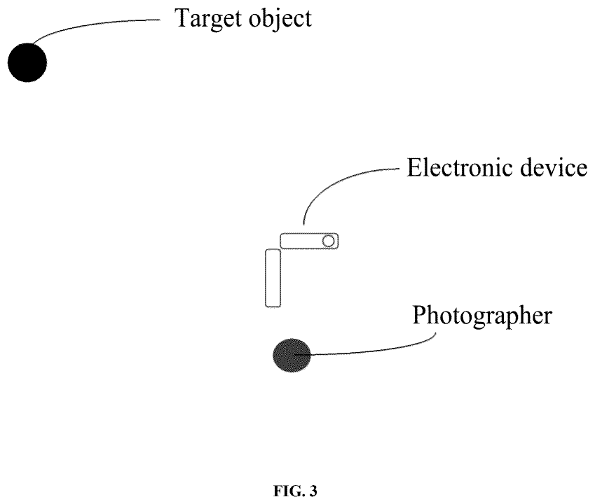

Referring to FIG. 3, it is a diagram of a first embodiment of a photographing method for automatically tracking a target object according to an embodiment of the present invention. When a user needs to take a video of a moving target object, the user can hold a part of a second screen and first take multi-angle photos of the target object through a camera, or select a plurality of pictures including the target object from a photo album. Or, the user can take a video of the target object in a plurality of angles and record the video into an electronic device, or input a name of the target object to the electronic device through speech or text. Or, the user can manually tap the target object on a current photographed image of the electronic device. When photographing is started, an actuator will automatically adjust a rotation angle between a first screen and the second screen, and automatically track the target object to ensure that the target object in a moving state can always be located in a center of the photographed image.

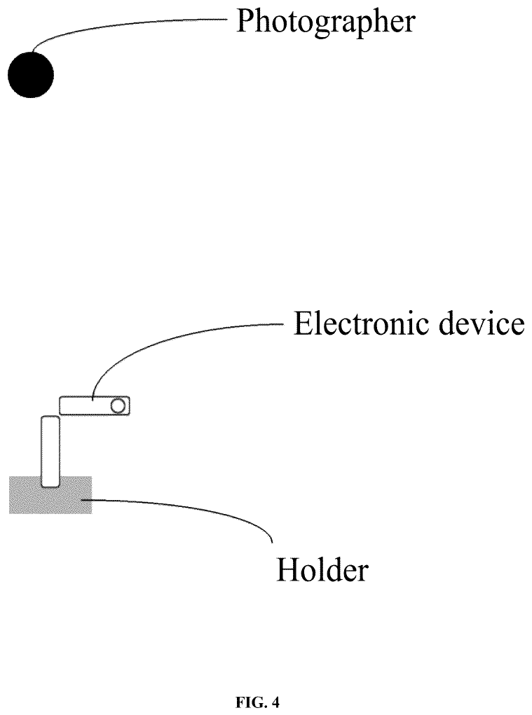

Referring to FIG. 4, it is a diagram of a second embodiment of a photographing method for automatically tracking a target object according to an embodiment of the present invention. When a user needs to take a selfie, the user can fix a second screen on a common mobile phone holder to ensure that a first screen can rotate freely. Similarly, the user can take multi-angle photos of the user through a camera, or select relevant selfie pictures from a photo album. Or, the user can take a video of the user through the camera in a plurality of angles and record features of the user into an electronic device. When photographing is started, an actuator may automatically adjust a rotation angle between the first screen and the second screen, and automatically track the selfie taker to ensure that the user is always in a center of a photographed image. Certainly, the user can also control the camera to photograph the target object through a speech command, a Bluetooth command, or another way. All the above photographing modes are feasible.

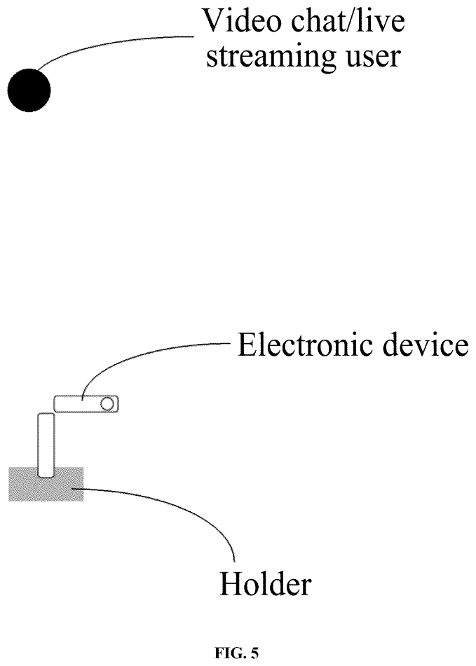

Referring to FIG. 5, it is a diagram of a third embodiment of a photographing method for automatically tracking a target object according to an embodiment of the present invention. When a user needs to engage in a video chat or a live streaming, the user can also fix a second screen on a mobile phone holder to ensure that a first screen can rotate freely and input a feature of a video chat or live streaming participant to an electronic device. When photographing is started, an actuator may automatically adjust a rotation angle between the first screen and the second screen and automatically track the video chat or live streaming participant to ensure that the video chat or live streaming participant is always located in a center of a photographed image. The present invention does not elaborate the above steps of how to ensure that the user is located in the center of the photographed image.

Certainly, the above photographing method for automatically tracking the target object provided in the present invention is not limited to the application embodiments provided above, and can also be applied to other photographing scenarios that require automatic tracking on a target object. The present invention does not impose further restrictions on this.

According to the photographing method for automatically tracking the target object provided in the present invention, the target object is input to the electronic device. By performing the feature extraction on the target object through the electronic device, whether the target object is located in the center of the current photographed image is determined in real time in the photographing process. If it is determined that the target object is not located in the center of the current photographed image, the first screen is controlled to rotate relative to the second screen until the target object is adjusted to the center of the photographed image. The present invention can automatically track the target object to ensure that the target object is located in the center of the photographed image, thereby providing a user with a stable and coherent photographing experience.

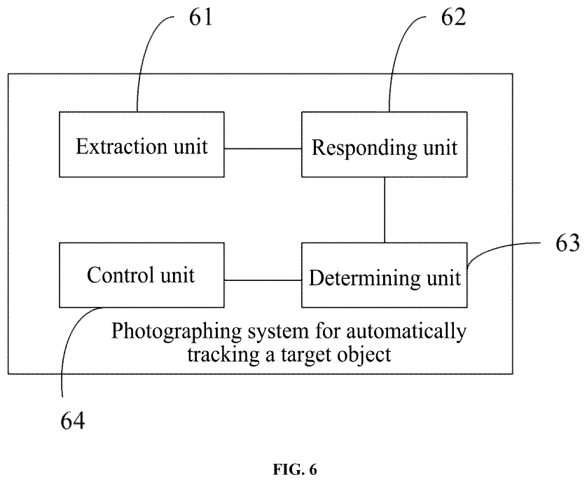

On the basis of the above photographing method for automatically tracking the target object, the present invention provides a photographing system for automatically tracking a target object. Referring to FIG. 6, it is a schematic structural diagram of a photographing system for automatically tracking a target object according to an embodiment of the present invention. The photographing system includes an extraction unit, a responding unit, a determining unit, and a control unit.

The extraction unit is configured to: record the target object into an electronic device, and perform feature extraction on the target object.

The responding unit is configured to: in response to a received photographing instruction, control a camera to photograph the target object.

The determining unit is configured to determine whether the target object is located in a center of a current photographed image.

The control unit is configured to: when the target object is not located in the center of the current photographed image, control a first screen to rotate relative to a second screen until the target object is adjusted to the center of the photographed image; and when the target object is located in the center of the current photographed image, continue to control the camera to photograph the target object.

For other details for implementing the technical solutions of the units in the photographing system for automatically tracking the target object provided in the above embodiment, refer to the description in the photographing method for automatically tracking the target object in the above embodiment. This will not be elaborated here.

It should be noted that the embodiments in this specification are described in a progressive manner, and each embodiment focuses on differences from other embodiments. The same and similar parts between all the embodiments can be referred to each other. Since the system embodiment is basically similar to the method embodiment, its descriptions are relatively simple, and related parts refer to some of the explanations of the method embodiment.

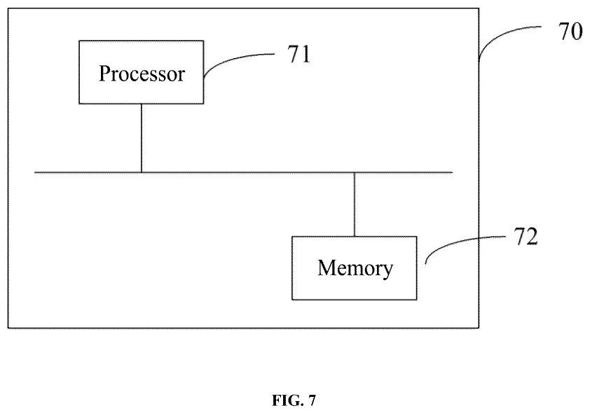

Referring to FIG. 7, it is a schematic structural diagram of a computer device according to an embodiment of the present invention. The computer device 70 includes a processor 71 and a memory 72 coupled with the processor 71.

The memory 72 has a computer program stored therein. The computer program, when executed by the processor 71, causes the processor 71 to perform the steps of the photographing method for automatically tracking the target object in the above embodiment.

The processor 71 can also be referred to as a central processing unit (CPU). The processor 71 may be an integrated circuit chip, which has a signal processing capability. The processor 71 can also be a general purpose processor, a digital signal processor (DSP), an application-specific integrated circuit (ASIC), a field programmable gate array (FPGA), or another programmable logical device, a discrete gate or transistor logical device, and a discrete hardware component. The general purpose processor may be a microprocessor, or the processor may be any conventional processor, or the like.

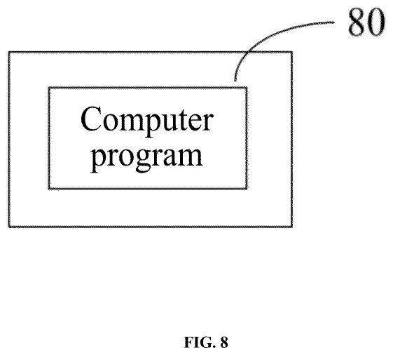

Referring to FIG. 8, it is a schematic structural diagram of a storage medium according to an embodiment of the present invention. The computer-readable storage medium of this embodiment of the present invention has a computer program 80 stored therein. The computer program 80, when executed by a processor 71, implements the steps of the photographing method for automatically tracking the target object in the above embodiment. The computer program 80 can be stored in the above storage medium in the form of a software product, including a plurality of instructions for causing a computer device (which may be a personal computer, a server, a network device, or the like) or a processor to perform all or part of the steps of the method in the implementations of the present invention. The foregoing storage medium includes: various media that can store program codes, such as a USB flash disk, a mobile hard disk drive, a read-only memory (ROM), a random access memory (RAM), a magnetic disc, and an optical disc, or a computer device such as a computer, a server, a mobile phone, and a tablet computer. The server can be an independent server, or a cloud server that provides a cloud service, a cloud database, cloud computing, a cloud function, cloud storage, a network service, cloud communication, a middleware service, a domain name service, a security service, a content delivery network (CDN), and a basic cloud computing service such as big data and an artificial intelligence platform.

In the several embodiments provided in the present invention, it should be understood that the disclosed terminal, apparatus, and method are achieved in other manners. For example, the above apparatus embodiments are merely illustrative. For example, the division of the units is only one type of logical functional division, and other divisions is achieved in practice. For example, multiple units or components can be combined or integrated into another system, or some features can be omitted, or not executed. In addition, the shown or discussed mutual coupling or direct coupling or communication connection is an indirect coupling or communication connection through some interfaces, apparatuses or units, and is in an electrical, mechanical or another form.

In addition, functional units in embodiments of the present invention may be integrated into one processing unit, or each of the units may exist alone physically, or two or more units are integrated into one unit. The integrated units mentioned above can be implemented in both a hardware form and a software functional unit form. The above describes only the implementations of the present invention and does not limit the patent scope of the present invention. Any equivalent structure or equivalent process transformation made using the specification and contents of accompanying drawings of the present invention, or directly or indirectly applied in other related technical fields, are equally included in the scope of patent protection of the present invention.

As described above, one or more embodiments are provided in conjunction with the detailed description, The specific implementation of the present invention is not confirmed to be limited to that the description is similar to or similar to the method, the structure and the like of the present invention, or a plurality of technical deductions or substitutions are made on the premise of the conception of the present invention to be regarded as the protection of the present invention.

What is claimed is:

1. A photographing method for automatically tracking a target object, applied to an electronic device, wherein the electronic device comprises a first screen provided with a camera and a second screen rotatably connected to the first screen; the first screen and the second screen are located on the same side of the electronic device; and the method comprises:
recording the target object into the electronic device, and performing feature extraction on the target object;
in response to a received photographing instruction, controlling the camera to photograph the target object;
determining whether the target object is located in a center of a current photographed image, and if it is determined that the target object is not located in the center of the current photographed image, controlling the first screen to rotate relative to the second screen until the target object is adjusted to the center of the photographed image; and
if it is determined that the target object is located in the center of the current photographed image, continuing to control the camera to photograph the target object.

2. The photographing method for automatically tracking the target object according to claim 1, wherein the recording the target object into the electronic device, and performing feature extraction on the target object comprises:
photographing a multi-angle picture of the target object through the camera, or selecting, from a photo album of the electronic device, a picture containing the target object as an information source, to extract a feature of the target object based on the picture of the target object;
or, inputting a name of the target object to the electronic device through speech or text, to cause the electronic device to automatically generate a feature of the target object;
or, manually tapping the target object on the current photographed image of the electronic device to implement the feature extraction on the target object,
wherein the feature of the target object at least comprises a first feature and a second feature.

3. The photographing method for automatically tracking the target object according to claim 2, wherein before the determining whether the target object is located in a center of a photographed image, the method further comprises:
extracting a first feature and a second feature in the current photographed image, and respectively comparing the first feature and the second feature of the current photographed image with the first feature and the second feature of the target object, to determine whether the target object is located in the current photographed image.

4. The photographing method for automatically tracking the target object according to claim 3, wherein the determining whether the target object is located in the current photographed image comprises:
comparing the current photographed image of the camera with the extracted first feature and the extracted second feature to obtain a first feature similarity and a second feature similarity of the current photographed image;
assigning weights to the first feature and the second feature, and determining, when a comprehensive similarity of the current photographed image is greater than a preset similarity threshold, that the target object is located in the current photographed image; and
on the contrary, if it is determined that the target object is not located in the current photographed image, controlling the first screen to rotate relative to the second screen until the target object is adjusted to the photographed image.

5. The photographing method for automatically tracking the target object according to claim 3, wherein the determining whether the target object is located in a center of a current photographed image comprises:
when the target object is located in the photographed image, determine contour position coordinates of the target object in the current photographed image based on the first feature of the target object;
determining center position coordinates of the target object based on a mean value of a plurality of contour position coordinates, and comparing the center position coordinates with coordinates of the center of the current photographed image;
when a difference between the center position coordinates and the coordinates of the center of the current photographed image is less than a preset threshold, determining that the target object is located in the center of the current photographed image; and
on the contrary, controlling the first screen to rotate relative to the second screen until the target object is adjusted to the center of the photographed image.

6. The photographing method for automatically tracking the target object according to claim 2, wherein the first feature is a shape feature of the target object, and the second feature is a color feature of the target object.

7. The photographing method for automatically tracking the target object according to claim 1, wherein an actuator is arranged between the first screen and the second screen, and the actuator is configured to control the rotation of the first screen relative to the second screen and hover the first screen to a desired photographing angle.

8. A photographing system for automatically tracking a target object, configured to perform the steps of the photographing method for automatically tracking the target object according to claim 1, wherein the photographing system comprises:
an extraction unit, configured to: record the target object into an electronic device, and perform feature extraction on the target object;
a responding unit, configured to: in response to a received photographing instruction, control a camera to photograph the target object;
a determining unit, configured to determine whether the target object is located in a center of a current photographed image; and
a control unit, configured to: when the target object is not located in the center of the current photographed image, control a first screen to rotate relative to a second screen until the target object is adjusted to the center of the photographed image; and when the target object is located in the center of the current photographed image, continue to control the camera to photograph the target object.

9. A computer device, comprising a processor and a memory coupled with the processor, wherein the memory has a computer program stored therein, and the computer program, when executed by the processor, causes the processor to perform the steps of the photographing method for automatically tracking the target object according to claim 1.
